(19) United States
(12) Patent Application Publication
(10) Pub. No.: US 2020/0202416 A1
(43) Pub. Date: Jun. 25, 2020

(54) SMART DISPLAYING SYSTEM

(71) Applicant: FEDERAL AKILLI ULASIM VE TEKNOLOJI COZUMLERI ANONIM SIRKETI, Istanbul (TR)

(72) Inventor: Erhan Ilker ARK, Istanbul (TR)

(21) Appl. No.: 16/612,597

(22) PCT Filed: Nov. 22, 2017
(86) PCT No.: PCT/TR2017/050581

§ 371 Date: Nov. 11, 2019

(30) Foreign Application Priority Data
May 31, 2017 (TR) 2017/07972

(51) Int. Cl. G06Q 30/06; G06Q 10/08; G06Q 30/02; G06K 7/10; G06K 19/077; H04W 4/23; H04W 4/80; H04W 4/02

(52) U.S. Cl. CPC G06Q 30/0639; G06Q 30/0643; G06Q 10/087; G06Q 30/0281; H04W 4/027; G06K 19/07773; G06K 19/07758; H04W 4/23; H04W 4/80; G06K 7/10366

(57) ABSTRACT

A smart displaying system is disclosed that detects which product is moved and enables the introductory video/visual image and/or content of the product moved by the customer to be shown automatically by interpreting the movement data of the products displayed in technology markets, shopping centers and every place where products are sold and displayed.

### TECHNICAL FIELD

The present invention is related to a system that enables the video and/or content of the product moved by the customer to be played at that moment automatically in the technology markets, shopping centers and every place where the products are sold and displayed.

The present invention is especially related to a smart displaying system that interprets the movement data of the products displayed and detects which product is moved by the customer without requiring that the product must be in a determined location, and plays the introductory video and/or visual images of the product moved, and a method thereof.

### STATE OF ART

In the places where the products are displayed, a customer interested in a product reads the limited information around the products s/he is interested in or must consult with the authorized person. Usually, sales and displaying message offered by the producer to the customer cannot be achieved completely due to said limited methods/opportunities. The producers producing products and/or service take the risk of making great effort and paying higher costs and prepare introductory videos in order to introduce their products better and increase the sales. However, due to the fact that placing an individual video playing screen for each product requires higher costs and physical conditions are limited, the producers must provide introductory videos to the customers on a single screen in an arranged or random manner in the places where many of the products are displayed.

Therefore, the customer cannot access the information regarding the product s/he is interested in since the content information of the products in a limited number can be transferred to the customer in a real-time period. Thus, the producers and companies making product displays, desire to use systems for playing the introductory video of the product in which the customer is interested at that time when the customer is at the aisle. It has been determined that said methods increase the sales. However, the present systems listed below cannot become widespread due to disadvantages mentioned.

The working methods and disadvantages of the present systems, which have been found in the researches made, are as follows;

1. Cable Video Playing Systems

A cable is attached onto the products and freedom of movement as much as the length of the cable is offered. If the product is available for moving, this system can be used. When the product is moved, the cable tightens, the switch to which the cable is attached, triggers the video and video is played on the screen.

### Technical Problems and Disadvantages of Cable Video Playing Systems

It can be applied for a limited number of products. Cabling for each of hundreds of products at different locations in an area is not possible physically and causes visual pollution.
It can only be applied to the products that are located in a certain area and available for moving.
Attaching the products with a cable leads to an unpleasant view.
The product cannot be viewed completely due to the cable.
A limited area is offered to the person viewing the product.
The product cannot be seen totally as the cable is in front of or on the product.

2. Video Playing Systems with Sensor or Button

In said systems, interlocked apparatuses and magnets are placed on the products and the places where the products are located. When the product is moved, the interlocked apparatuses are separated from each other and the video belonging only to that section is played.

### Technical Problems and Disadvantages of Video Playing Systems with Sensor and Button

Placing the interlocked products on each of the products and under the place where the product is located requires higher costs than expected and is hard to install.
As the videos are identified for each of the sensors in the place where the product is located, rather than the product itself, wrong video will be played in the case that the product is located in the wrong place. As the customers do not generally put the product back, said method leads to wrong video playing.
The systems based on the customers pushing the button and playing the video do not generally attract the customers. Detecting which button belongs to which product and pushing the button when s/he examines each product causes troubles for the customer.
It can be applied for a limited number of products. Placing sensor, cabling and/or placing button for each of hundreds of products at different locations in an area is not possible physically and causes visual pollution.
It can only be applied to the products that are available for moving.

3. Smart Shelf Video Playing Systems:

The application numbered TR2013/05286 found as a result of technical researches may be an example to said systems. In said application, RFID tags are attached on the products and RFID antennas placed on the shelves are connected to RFID readers and the system is formed. Said system can be used for both stock tracking and playing visual images. In said system, the devices that are expensive and difficult to install such as RFID reader, RFID antenna and RFID antenna multiplexer are used. Additionally, passive RFID tags are used in the system. Passive RFID tags are activated with the power provided by the antenna. Therefore, passive RFID tags are limited to reading areas. Especially in metallic mediums, in the mediums and products containing water, and in the products, which are closely spaced and placed successively, reading the RFID tag of the product and playing video may be impossible. In order for the antennas placed to perform reading correctly, their angles must be adjusted separately for each of the antennas. Correct results cannot be achieved every time and additional labor and costs are required for installing the system. RFID passive tags are generally disposable and a new RFID tag is required for each product. Thus, costs are increased. Moreover, placing RFID antenna cable in the places where the products are displayed is not possible.

### Technical Problems and Disadvantages of Smart Shelf Video Playing Systems

It can be applied for a limited number of products due to high reader costs.
Placing RFID antenna reading system at each point and cabling for thereof in order to define hundreds of products at different locations in an area may not possible physically and causes visual pollution.
It can only be applied to the products that are located in a certain area and available for moving.
As there are not motion sensitive sensors on passive RFID tags, the video of the product is not detected in a motion sensitive manner, but it is detected by the system when it is within/out of the reading range and the video can be played.
As the frequencies such as 865-869 Mhz used in passive RFID system perform cloud broadcasting, limiting the RFID reader and antenna reading range with certain lines is not possible technically. Therefore, the precise time when the product in which the customer is interested, is included in and excluded from the reading area cannot be detected clearly and the success rate of the system decreases due to said technical problem. This, in turn, decreases the video watching possibility of the customer and wrong videos may be played.

The abovementioned three systems do not satisfy the needs of both producers and customers at the desired level due to technical disadvantages thereof.

As a result of abovementioned disadvantages and insufficiency of present solutions regarding the subject, an improvement is required in the related technical field.

### PURPOSE OF THE INVENTION

Developed by being inspired of the present conditions, the present invention aims to eliminate the abovementioned problems.

The objects of the present invention and technical problems eliminated by the invention are listed below:

The wireless identification devices to be put on the products can be removed from the product when said product is sold and attached to/fixed on a different product and used again. Therefore, the problem arising with the use of disposable tags is eliminated.

The wireless identification device comprises magnetic sensor that changes when the displayed product is moved and/or motion sensor detecting X, Y and Z coordinates. As the wireless identification devices with motion sensor are fixed on the products displayed, it is not necessary to put the product back in the displaying area and the risk of playing wrong video is eliminated.

Thanks to the algorithm data system developed, the change in X, Y and Z coordinates, which is sent from wireless identification device, which one of the products displayed are moved and whether said movement occurs as a result of a vibration and a crash, or occurs due to a person who is interested in the related product, are automatically detected by the reader. Thus, a system based on human behaviors is developed and unnecessary triggering processes are eliminated.

Additionally, the need for pushing the button and problems arising from cabling for each product are eliminated. Thanks to our data system that will detect the movement information in all of the products which are available for moving and are displayed (e.g. bed, fridge door, armchair and etc.), the problem arising from moving only the products that can be replaced is eliminated.

In addition, additional cost factors such as reader, antenna, antenna multiplexer and cabling are not required and devices that can be supplied easily and are greatly present on the market such as computers, tablets are used and therefore, the problems arising from increase in costs are eliminated.

The present invention can be used with radio frequency technologies which can transfer data wirelessly, such as Bluetooth, BLE, Beacon and RFID. BLE (Bluetooth Low Energy) is a Bluetooth technology that broadcasts in the form of small data packages and has low energy consumption.

Bluetooth 4.0 is the current version of wireless data communication technology provided in many electronic devices such as smart phones, tablets and TVs. The present invention is also compatible with the new versions of Bluetooth 4.0 and Bluetooth 5.0 technology.

Bluetooth 4.0 is especially important in terms of energy saving. New technology ignores maintaining constant flow and focuses on transferring small data bits when required. In BLE technology, data are transferred without connecting to Bluetooth devices. The data transferred, send a certain ID instead of huge contents. As high level of power is not consumed in order to transfer data, battery life prolongs and data can be transferred to long distances.

In the system according to the present invention, all the systems that can perform wireless data transmission can be used when required. Said wireless identification devices can be beacon, RF and other technologies.

The wireless identification devices used in the system according to the present invention comprise motion sensor. Motion sensor can detect the movements on three axes (X, Y, Z). X, Y and Z value obtained when the movement is detected, is sent to the reader wirelessly by wireless identification device.

Thanks to the invention, wireless identification devices will be positioned on the products, when the product is moved, the changes in the motion sensor will be sent to the reader and which product is moved and whether this movement is real or involuntary vibration will be detected by data system algorithm and content video of the product displayed will be played on the visual system. Additional hardware will not be needed for running the system and readers having Bluetooth hardware will run the system directly or by being connected to the present visual systems.

The structural and characteristic features and all the advantages of the present invention will be more clearly understood thanks to the FIGURES below and the detailed description written with reference to those FIGURES and thus, the evaluation needs to be done by taking said FIGURES and the detailed description into consideration.

### FIGURES FOR UNDERSTANDING THE PRESENT INVENTION

FIG. 1 is the view of smart displaying system according to the present invention.

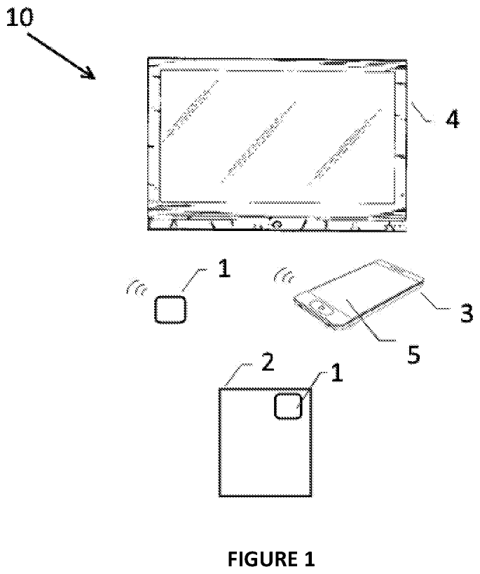

The drawings do not need to be scaled necessarily and the details that are not necessary for understanding the present invention may have been ignored. In addition, the elements that are identical to a great extent or have identical functions to a great extent are referred with the same numeral.

### DESCRIPTION OF THE REFERENCES

10. Smart Displaying System
1. Wireless identification device
2. Product
3. Reader
4. Visual System
5. Data System

### DETAILED DESCRIPTION OF THE PRESENT INVENTION

In this detailed description, the preferred embodiments of the present invention are described only for the subject to be understood better without any limiting effects.

The present invention is related to a smart displaying system (10) developed in order to be used in technology markets, shopping centers and every place where the products (2) are sold and displayed, and a method thereof. The system interprets the movement data of the products (2) displayed and detects whether the products are moved by the customer and which product (2) is moved by the customer without requiring that the product (2) in the displaying area must be at a determined position. Moreover, the system also enables the introductory video/visual image and/or content of the product (2) contacted/moved by the customer to be showed automatically at that moment.

The smart displaying system (10) according to the present invention is based on the product (2) which will be advertised, marketed, sold and introduced by the producer, the video/visual image and/or content of which will be played, the detailed information of which will be provided and which will be exhibited and/or stock of which will be tracked. Active/passive wireless identification devices (1) that will be positioned on the products (2) transfer the location information on x, y and z axes to the reader (3) wirelessly (by sending beacon, ibeacon and rf signals) thanks to magnetic sensor and/or motion sensor (accelerometer) therein. The reader (3) that reads the location signal on x and/or y and/or z axes received from wireless identification devices (1) connected to the product (2) wirelessly, transfers the information to the data system (5) installed therein. The reader (3) also transfers the video/visual image and/or content of the product (2) moved to the visual system (4) that will play thereof. When wireless identification devices (1) are fixed on the products (2) displayed, identifying the introductory visual images with the products (2) displayed is performed by means of data system (5).

The reader (3) may be integrated with the visual system (4) or the visual system (4) comprising screen and connection apparatuses is connected to the reader (3) and plays the video, visual image, photos and/or content of the products (2), which are saved on the data system (5) previously. The data system (5) that will be run on the reader (3) is a mobile/web application or computer program/software to be downloaded into the electronic devices such as phones, televisions, tablets and computers, which;
receives the location signals sent to the reader (3) from wireless identification device (1) connected with the products (2), and compares thereof with the previous location information constantly,
detects the product (2) that is moved after finding that the location information is not identical to the previous location information,
detects whether said movement is performed by a human, namely, it is a real movement instead of crash or a vibration,
plays the video, visual image and/or content of the product (2) moved in the visual system (4),
saves the movement and stock information of the products (2) in order to be reported when requested.

The method of the smart displaying system (10) according to the present invention is performed as follows;
introductory videos/visual images and/or contents matched with the products (2) are saved into the data system (5) installed in a reader (3) such as phone, tablet PC, box PC device and television, or in an external memory unit such as USB memory/SD card, or a remote cloud server accessed through internet,
the wireless identification devices (1) are positioned on the products (2),
the wireless identification devices (1) are matched with the product (2) on which they are fixed, through the data system (5),
the wireless identification devices (1) having motion sensor and/or magnetic sensor sends the location information signals of the product (2), on which they are positioned, on x, y and z axes to the reader (3) constantly and wirelessly,
the reader (3) transfers the location information to the data system (5) installed therein,
the data system (5) compares the location information received from wireless identification devices (1) with the previous location information constantly,
after the product (2) is moved by the customer, the data system (5) detects that the location information sent to the reader (3) is not identical to the previous location information by making comparison,
the data system (5) detects the product (2) connected with the wireless identification device (1) that sends location information different from the first location,
the data system (5) transfers the introductory videos/visual images and/or contents of the product (2) moved to the visual system (4) by means of reader (3) to play (the image may also be transferred to the different screens),
the data system (5) saves the movement and stock information of the products (2) in order to be reported when requested.

In order for wireless identification devices (1) to be used for other displayed products (2), fixing process can be performed directly on the product (2) and also to the box or package in which the product is present.

The present invention can be used in radio frequency technologies which can transfer data wirelessly, such as Bluetooth, Beacon, iBeacon and RFID.

1. A smart displaying system enabling the introductory video/visual image and/or content of a product contacted/moved by a customer to be showed automatically at that moment by interpreting the movement data of the products in every place where products are sold and displayed, characterized in comprising:
wireless identification devices that are positioned on the products and transfers the location information on x and/or y and/or z axes to a reader wirelessly thanks to magnetic sensor and/or motion sensor therein,
wherein the reader reads the location signal on x and/or y and/or z axes wirelessly received from wireless identification device connected to the product, transfers the information to a data system installed therein, and transfers the video/visual image and/or content of the product moved to a visual system that will play thereof;
wherein the visual system that plays the video/visual image, and/or content of the products, which are saved into the data system previously and comprises screen and connection apparatuses,
wherein the data system that received the location signals that are sent to the reader from the wireless identification device connected with the products and will be run on the reader, and compares thereof with the previous location information, detects whether the location information is identical to the previous location information and said movement is crash or vibration or real movement, and enables the video/visual image and/or content of the product moved to be played in the visual system and saves the movement numbers of the products and stock information in order to be reported when requested.

2. The smart displaying system according to claim 1, characterized in that the reader is a phone, television, tablet or computer.

3. A smart displaying method enabling the introductory video/visual image and/or content of a product moved by a customer to be showed automatically at that moment by interpreting the movement data of the products in every place where products are sold and displayed, characterized in comprising the following process steps:
saving introductory videos/visual images and/or contents matched with the products into the data system installed in a reader and/or in an external memory and/or a remote server accessed through internet,
positioning wireless identification devices on the products,
matching the wireless identification devices with the product on which they are fixed, through the data system,
the wireless identification devices having motion sensor and/or magnetic sensor sending the location information signals of the product, on which they are positioned, on x and/or y and/or z axes to the reader wirelessly,
the reader transferring said location information to the data system,
the data system comparing the location information received from wireless identification devices with the previous location information,
after the product is moved by the customer, the data system detecting that the location information sent to the reader is not identical to the previous location information by making comparison,
the data system detecting the product connected with the wireless identification device that sends location information different from the first location,
the data system transferring the introductory videos/visual images and/or contents of the product moved to the visual system by means of reader to play.

4. The smart displaying method according to claim 3, characterized in that the wireless data transmission is performed by means of Bluetooth, BLE, Beacon, iBeacon or RFID technologies.

5. The smart displaying method according to claim 3, characterized in that the data system saves the movement and stock information of the products in order to be reported when requested.
